(19) United States
(12) Patent Application Publication
(10) Pub. No.: US 2011/0257996 A1
(43) Pub. Date: Oct. 20, 2011

(54) Method for Electronic Delivery of Patient Health Records

(76) Inventor: Robert Smith, Chattanooga, TN (US)

(21) Appl. No.: 12/763,951

(22) Filed: Apr. 20, 2010

(51) Int. Cl. G06Q 10/00; G06Q 50/00

(52) U.S. Cl. 705/3

(57) ABSTRACT

A method is provided for collecting and electronically providing personal health information for registrants to emergency personnel by assigning a unique code to each registrant which is published in conspicuous locations and upon occurrence of an emergency situation involving the registrant, registrant's health information is released to authorized medical personnel who provide the registrant's unique code with a request for health information.

### TECHNICAL FIELD

The present invention relates to a method for electronically storing a patient health record and electronically delivering medical information from the patient health record to emergency or other medical personnel.

### BACKGROUND OF THE INVENTION

When an individual is involved in an emergency situation, the common and preferred first action is to notify the family of the individual. The current protocol requires only that emergency professionals attempt to locate a drivers license and call the individual's home phone number. In situations where the emergency is a serious accident, such as an automobile accident, and where the individual is unable to communicate with rescue or medical personnel, contact with the individual's family may be the only way that medical professionals can become aware of any special medical needs or problems relating to the individual. Absent quick contact with the family of an injured individual, the care of the injured may be compromised by lack of critical information. Commonly owned U.S. patent application Ser. No. 11/676,943 provides a method of registration where a registrant is assigned a unique code, which is published in conspicuous locations, such as the window of a car, in a wallet or a purse, and on a small decal affixed to an identification card. Upon the occurrence of an emergency situation involving the system registrant, emergency personnel contact the data center and provide the unique code. The data center then contacts at least one of the persons whose contact information has been provided by the system registrant.

While the existing system is beneficial, shortcomings still exist. For instance, for injured persons who are not registered with the notification system, the protocol of calling a home phone number fails to take into account that many people use only mobile phones and email. Even for homes with land lines, there may not be anyone home to receive a call. For injured persons who have registered with a notification service, it may be possible to make contact with an injured individual's family. Some family members are able to provide background information on the injured person that will enable emergency personnel to make more informed judgments as to a proper course of action.

However, not all of an individual's contacts are appropriate sources of accurate medical information that can be utilized by emergency personnel. For instance, emergency medical personnel generally need to be aware of a patient's current medications, allergies, previously diagnosed existing medical conditions, blood type, and current physician(s), and ultimately, insurance information. It is unrealistic that anyone other than a primary caregiver would have all of this information available for anyone with significant existing medical issues. Even for such an informed person, transmission of all of the information by phone could be time consuming and subject to error due to memory lapse or mistakes in communication. As a result, particularly persons with allergies or ongoing medication regimens are well served by an emergency registration service that makes vital medical information available to emergency providers by electronic communication. In an optimal situation, information recorded in an electronic health record may also be utilized by the individual and the individual's regular physicians to monitor, manage, and treat health conditions.

Accordingly, a need exists for better methods for emergency personnel to access information that will enable the emergency services providers to exercise their informed medical judgment, and to avoid exacerbating any preexisting health conditions.

### BRIEF SUMMARY OF THE INVENTION

The foregoing needs in the area of emergency medical treatment are accomplished by the combination of aspects of an online personalized health record service with a personalized emergency notification service.

An individual who is registered with the system (the “system registrant”) may provide two types of information. The first, and optional, type of information is for personalized emergency notification and includes contact information for at least one, and preferably two or more, predetermined contacts. The contact information may include multiple phone numbers, email addresses, office and home addresses and similar means of contacting the predetermined contact(s). The second type of information is health record information that may include contact information for primary care physician(s), an indication of whether religious beliefs affect treatment, insurance information, current medication information, allergy information, lifestyle matters that are commonly considered medically significant, blood type, prior medical diagnoses and treatments, and personal and family medical history information.

The collection of contact and health record information for the system registrant is associated with that registrant in a database residing at a data center and a unique registration code is assigned to the system registrant linking the system registrant to this information.

A registered individual is then issued personalized ID cards, tags and decals. Cards may be placed in wallets or purses behind a drivers license and decals may be placed on vehicle windows, and special smaller sized decals may be affixed to student identification cards. Silicone wrist bands or bracelets and shoe tags may all optimally be employed depending upon the choices of the individual.

When an emergency occurs, and if the system registrant is unable to communicate necessary information to the responding emergency personnel, the emergency personnel contact a call center and, utilizing the unique registration code, alert the call center to the need for medical information. The call center is staffed with personnel trained to handle personal medical information, and when appropriate, to access information in the data center and provide health record information to the emergency personnel. In a preferred embodiment, the call center personnel may electronically transmit a pre-determined selection of critical medical information to the requesting medical personnel.

### BRIEF DESCRIPTION OF THE DRAWINGS

These and other features, aspects and advantages of the present invention will become better understood with regard to the following description, appended claims and accompanying drawings, where:

FIG. 1 is a schematic diagram providing an overview of the communication system and data utilized in the medical information system.

FIG. 2 is a flow diagram illustrating steps in executing an exemplary embodiment of the emergency health record delivery system.

FIG. 3 is an exemplary data input screen utilized by a system registrant in providing health record information.

FIG. 4A-4C is an exemplary personal health record for a system registrant.

FIG. 5 is an exemplary call center operator screen including a “transmit personal health record” option.

### DETAILED DESCRIPTION OF THE INVENTION

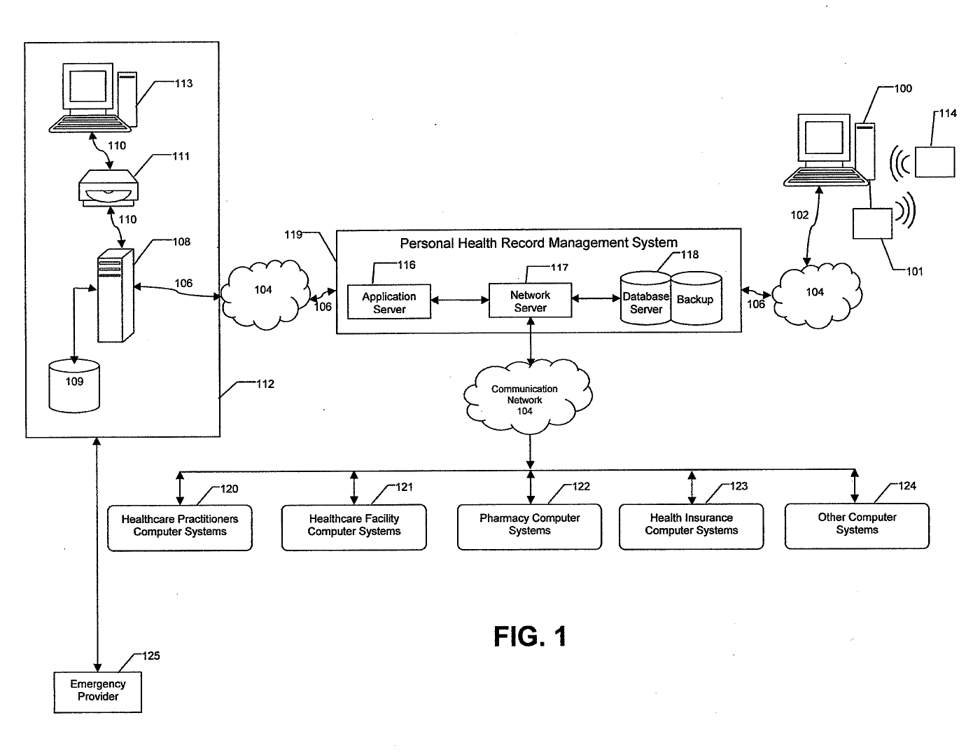

Turning then to FIG. 1, an overview of the personalized health record system is illustrated, a personal health record management system is operated at a location 119 and would typically comprise at least an application server 116, network server 117, and database server 118. The personal health record management system is illustrated with communication connections 102, 106 to a computer or work station 100 operable by a system registrant, to a call center location 112 and optionally to a variety of health care related services such as health care practitioners 120, health care facilities 121, pharmacies 122, insurance companies 123, and other approved providers or recipients of health care information, possibly including laboratories, trainers, rehabilitation facilities and researchers. The work station 100 for system registrant is shown in an enhanced embodiment including a radio frequency enabled receiver 101 adapted to communicate with radio frequency enabled device 114 containing health care information, for instance, a glucose monitoring device, workout/fitness recording device, medication management device, or the like. Preferably, such monitoring data can be automatically requested and received by radio frequency connection such as Bluetooth, however, alternatively, devices collecting such information may be connected to work station 100 as by USB port, or may have a memory card or flash drive that is removed and connected to work station 100.

In an advanced personal health record management system, the system registrant's health and medical data is entered not merely by the registrant, but also by a variety of health care providers. For instance, health care practitioners 120, such as a primary care physician, may be authorized to provide updates to system registrant's personal health record. The system registrant may even authorize a health care practitioner, such a primary care physician, to access the personal health record which might contain a test ordered by other physicians, medication usage that can be discerned from pharmacy records, and monitoring information that has been collected through the registrant's work station 100 or other sources, The present invention is particularly adapted to work in connection with a call center 112 which may be connected to the personal health record management system location 119 through a more secure communication linkage 106 such as a Virtual Private Network to permit rapid access to personal health records. The call center 112 will typically have at least one local server 108 with local database 109 that is updated to contain system registrant identifiers connected by local network 110 possibly using one or more local routers 111 to connect with call center operator work stations 113. Emergency providers 125 are able to contact the call center from information on system registrant's cards or stickers and provide the system registrant's unique identifier to the call center operator in order to be provided information concerning the registrant.

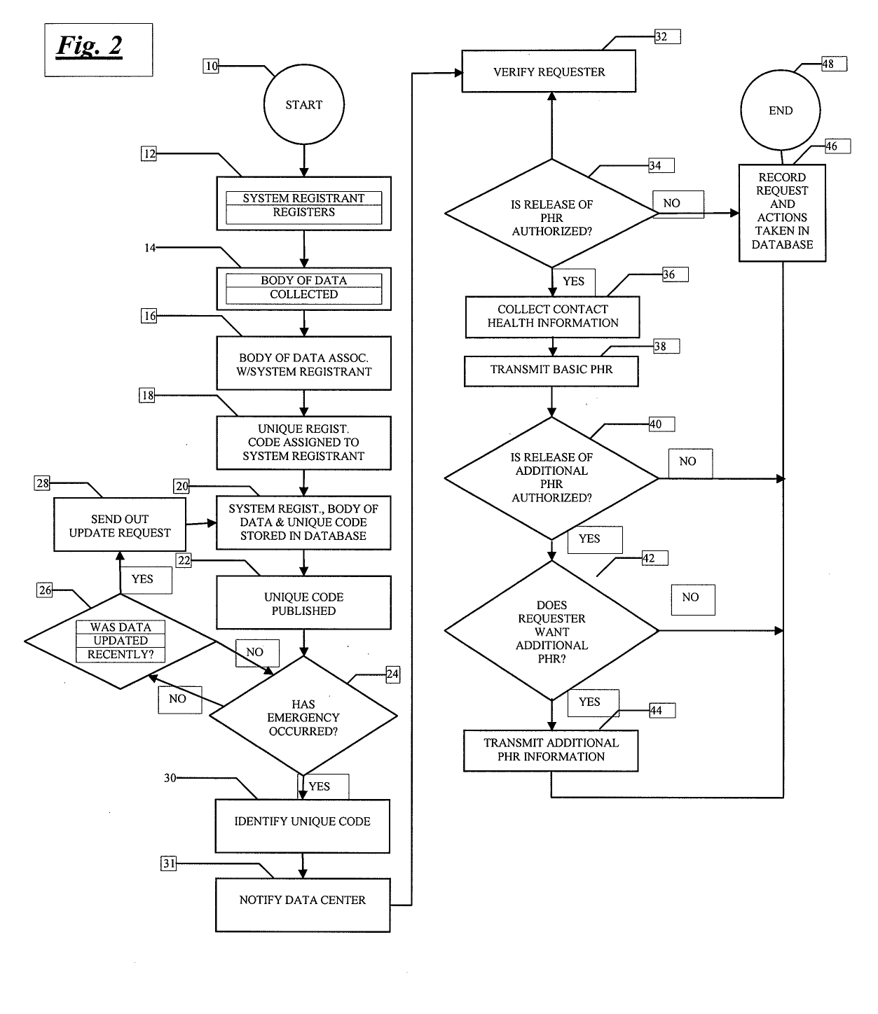

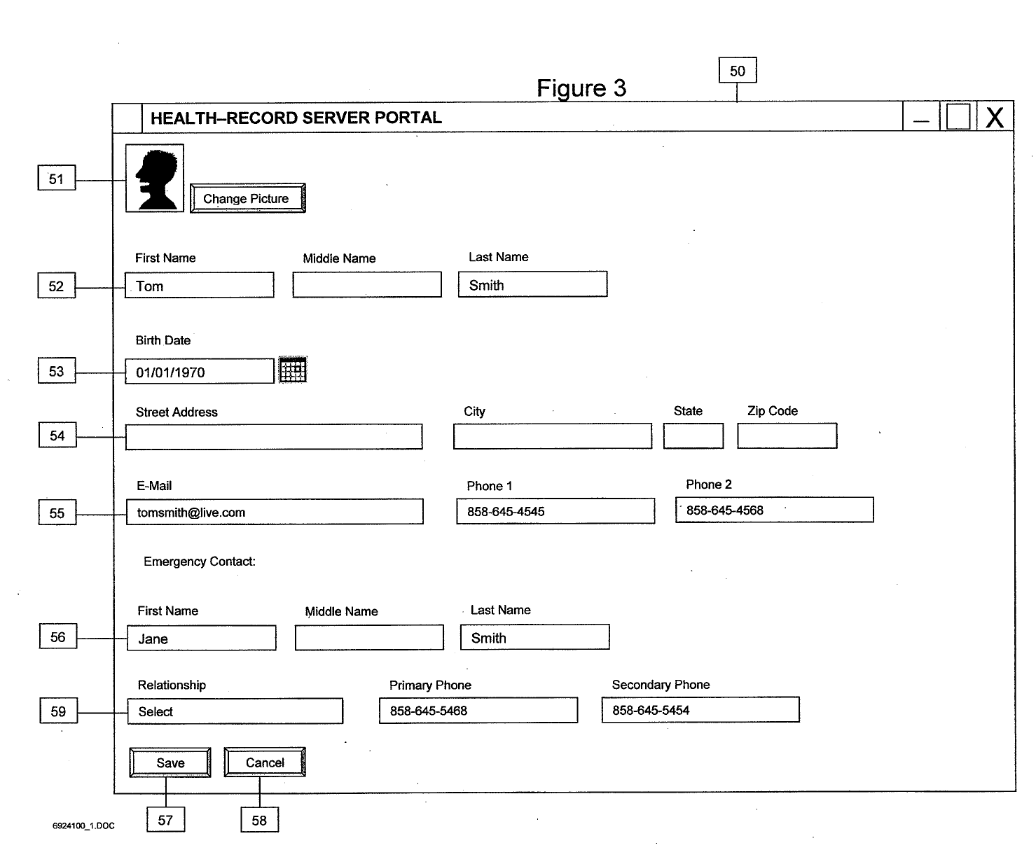

FIG. 2 illustrates a typical sequence of events demonstrating the use of the system. A system registrant may register for the service as depicted in step 12 and the registrant agrees to the contractual terms of service. At step 14, a body of data is collected relating to the registrant. This may optionally include contact information including predetermined contacts such as a spouse, parents, children, other relations, neighbors, friends, physicians, etc. Most significantly for the purpose of the present invention, the body of data will include personal health information relating to the registrant. In this regard, the registrant may utilize a data input screen 50 such as depicted in FIG. 3 where the registrant is allowed to upload a photograph or select an avatar 51 and is requested to input name 52, birthdate 53, address 54, email and phone numbers 55. Also shown is the optional emergency contact name 56, the selection of relationship with the contact 59, and buttons to save data input or to cancel the data input operation 57, 58. In addition to this basic demographic information, other data collection pages are preferably available to collect information concerning medications, allergies, diagnosed medical conditions, as well as health history information such as family health history, immunization history, medical procedure history, and measurements and test results such as blood glucose measurements, blood pressure measurements, height, weight, peak flow measurements, and various lab test results. In addition, the personal health record may collect a variety of documents which may include a continuity of care document, continuity of care record, and living will, as well as digital MRI, x-ray and other image files and the like.

Once the body of data is assembled, it is maintained in the data center 119 where it is preferably associated in a secure and encrypted database with the identity information of the system registrant as shown in Step 16. In Step 18, a unique registration code (hereafter “code”) is created and assigned to the system registrant so that by knowing only the code, both the identity of the system registrant and the identity of the body of data relating to the registrant can be determined. Thereafter, the information relating to the system registrant, the body of data and the code are stored in a database within the data center as shown in Step 20. At Step 22, the code is “published” in at least one prominent location.

By “published” it will be understood that the code may be placed on a sticker and positioned in a window of a vehicle such as an automobile, motor home, boat, or airplane. Additional publishing may include an identification card or tag which the system registrant keeps on his or her person in a location such as a wallet or purse. For the student market, small decals may be affixed to a student ID card or similar sized card without obstructing information required to be displayed on the card. Other items including shoe tags for runners or children, backpack tags, silicone bracelets, helmet stickers, key fobs, luggage tags, cell phone stickers and home window or mailbox stickers are additional options to accomplish the same function.

Importantly, contact information for the data center is co-positioned with the code. Contact information may include a phone number for the data center, but may also include the data center's website or facsimile number. In any event, the publishing should be sufficient to indicate to emergency personnel (a) how to contact the data center and (b) the code to be given the center. This will allow the service to operate to provide not only contact data, but also personal health information to emergency personnel and treating physicians even when the registrant is unconscious or incoherent. At this point, the registration of the system registrant is complete.

After the registration, the data center awaits an inquiry regarding a registrant shown at decision block 24. If, as depicted in decision block 26 a predetermined number of months have passed with no emergency involving the registrant and further if the registrant has not updated their body of data, a request for updated data may be sent to the registrant as shown in Step 28. After the request is sent, the method of the present invention returns to Step 20 and progresses accordingly. If, on the other hand, there has been updated information provided to the body of data by the system registrant by the predetermined period of time, the present invention returns to decision block 24.

If an emergency occurs, it is incumbent upon the responding emergency personnel to identify the publication, be it on a window and a wallet, or elsewhere, and then identify the code depicted in Step 30. Then in Step 31, the emergency personnel notify the data center of the identity of the emergency personnel making the call, the code ascertained from the publication, and requests appropriate assistance from the call center. The call center should be staffed 24 hours a day, every day of the year, with appropriately trained personnel, such as those having National Academies of Emergency Dispatch certifications. Contractual agreements with the call center assure not only appropriate staff training and certification, but also compliance with health information and privacy laws and regulations.

The request for assistance may simply be to obtain a contact for the system registrant or alternatively may include a request for health information. In this case, the call center first verifies that disclosure of the system registrant's health information to the requestor is authorized both according to the terms of system registrant's agreement and according to appropriate laws as shown in Step 32. As seen in decision block 34, if the release of information is not authorized, the request is recorded along with the action taken in database in Step 46. In this instance, the action taken would be denying the request for information. On the other hand, if the release of the personal health record information is authorized, the call center proceeds in Step 36 to collect electronic contact health record information to communicate the information and proceeds in Step 38 to transmit at least the system registrant's basic personal health record data which would include at least current medications and allergies. Optionally, the call center may, in decision block 40, determine whether the system registrant maintains additional personal health record information and if so may, in decision block 42, advise the requesting personnel and inquire as to whether such information would be helpful. In the event the requestor wants additional personal health record information, that additional information is transmitted in Step 44. The call center, regardless of the steps taken, finally records the request and actions taken in Step 46 concluding a particular transaction. All communications of personal health information are made in compliance with applicable laws and regulations including HIPAA and the HITECH Act.

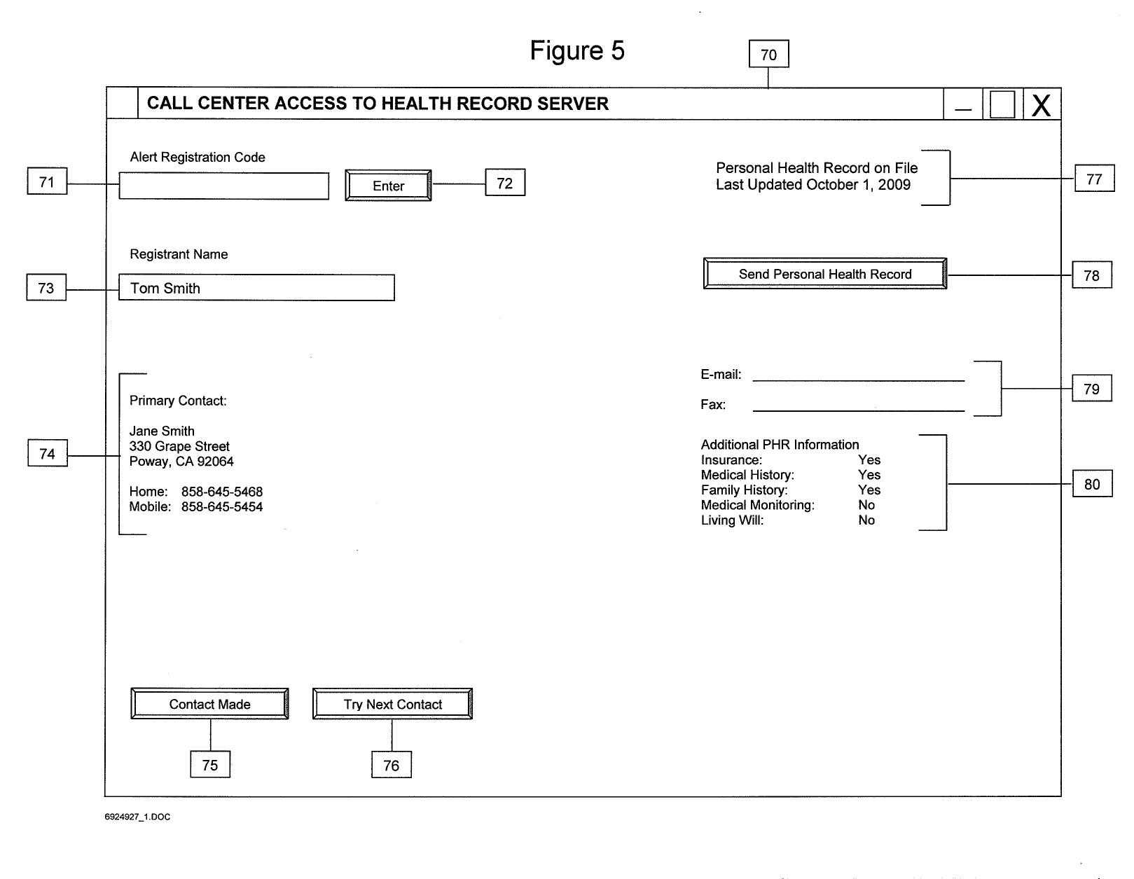

A representative call center operator screen 70 is depicted in FIG. 5 including a data field 71 for the unique code and an enter button 72 to process the code to recall the registrant's name 73, primary contact information 74, and buttons to confirm the contact was completed 75 or to retrieve additional contact information 76. When the registrant has provided a personal health record information, that is indicated in location 77, email or fax addresses to transmit personal health record information to a requestor are to be entered by the call center operator in data field 79, and a send button 78 is provided to enable the call center operator to quickly transmit at least the basic personal health record information. The existence of additional personal health record information is disclosed in location 80 in the event that it is desired by the requestor.

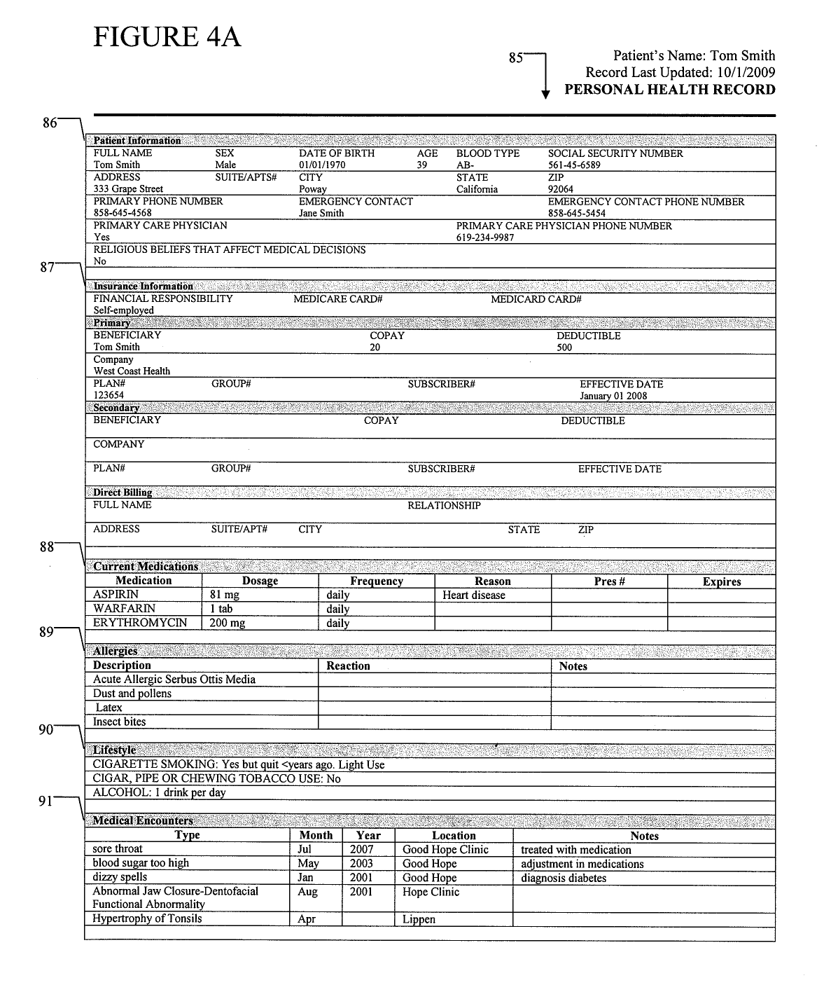

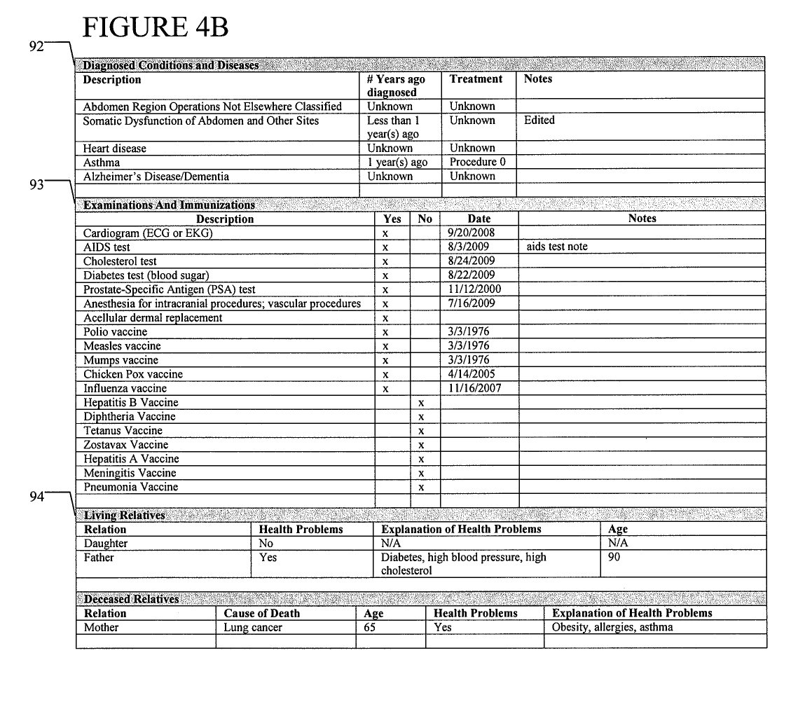

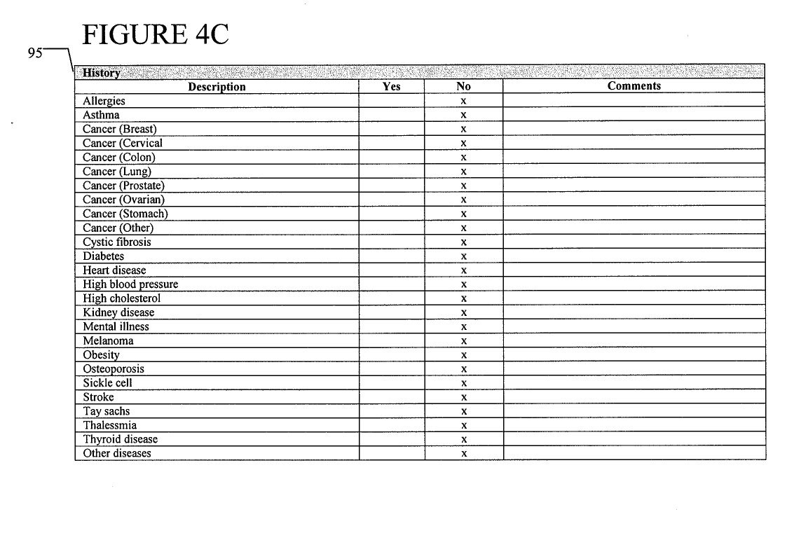

FIG. 4A-4C discloses a form 85 of expanded basic personal health record information that might be transmitted to a requestor including registrant demographic information 86, insurance information 87, medication information 88, allergy information 89, lifestyle data 90, medical encounter history 91, diagnosed conditions and diseases 92, examinations and immunizations 93, family medical history 94, and registrant history 95.

It will be understood and appreciated that the foregoing description of a preferred embodiment of the present invention is intended to be representative in nature. The scope of this invention should, therefore, be limited only by the scope of the amended claims and equivalents thereof.

I claim:

1. A method for providing personal health information relating to a system registrant in a medical treatment situation comprising the steps of:
(a) gathering from the system registrant a body of personal health information;
(b) associating the body of health information with the system registrant;
(c) assigning the system registrant a unique registrant code for identifying the system registrant and the associated body of health information;
(d) publishing the unique registration code in a prominent location associated with the system registrant in proximity to system contact information;
(e) storing the body of health information in a database, and, responsive to the occurrence of an emergency situation involving the system registrant;
(f) utilizing the unique registrant code to access the body of health information;
(g) determining the release of the system registrant's health information is authorized;
(h) collecting the communication address to send the system registrant's health information; and
(i) electronically transmitting the system registrant's health information for use in providing medical treatment.

2. The method of claim 1 wherein emergency contact information is gathered from the system registrant.

3. The method of claim 1 wherein the system registrant is periodically requested to update health information.

4. The method of claim 1 wherein the system registrant can update the health information to include data from at least one of a glucose monitoring device, a workout/fitness recording device, and a medication management device.

5. The method of claim 1 wherein the system registrant's health information may be updated by at least one of a healthcare practitioner, a healthcare facility, a pharmacy, and a health insurer.

6. The method of claim 1 wherein the system registrant's health information includes at least information concerning medications, allergies, and diagnosed medical conditions.

7. The method of claim 6 herein personnel at a call center determined whether the release of the system registrant's health information is authorized.

8. The method of claim 7 wherein personnel at the call center are able to transmit at least information concerning medications, allergies, and diagnosed medical conditions utilizing a send command.

9. The method of claim 8 wherein personnel at the call center are able to transmit additional health information upon request and including at least one of insurance information and medical encounter history.

10. A method of providing personal health information for a system registrant in an emergency wherein a system registrant provides a body of health information that is associated with the system registrant, the system registrant is assigned a unique registration code for identifying the associated body for health information, the unique registration code is published in a prominent location, and the body of health information is stored in a database so that responsive to the occurrence of an emergency situation involving the system registrant, in response to the unique registration code that database may be accessed to locate the body of health information relating to the registration code and upon verification of authorization for release of the health information, the health information is electronically transmitted for use in providing medical treatment in the emergency situation.

11. The method of claim 10 wherein the unique registration code is published on at least one of a personalized ID card, tag, decal, wristband, shoe tag, sticker, and keyfob.

12. The method of claim 10 wherein the body of health information includes at least medication information, allergy information, and diagnosed conditions and diseases.

13. The method of claim 10 wherein in addition to the body of health information, emergency contact information for the system registrant is also stored in the database.

14. The method of claim 10 wherein the body of health information includes wellness information relating to the system registrant's lifestyle that may affect health and well-being.

15. The method of claim 10 wherein the system registrant is periodically requested to update the body of health information.

16. The method of claim 10 wherein the system registrant's body of health information may be updated by at least one of a healthcare practitioner, a healthcare facility, a pharmacy, and a health insurer.

17. The method of claim 10 wherein each request for the release of health information is recorded together with a description of the action taken in response to that request.

18. A system for collecting personal health information for registrants and electronically providing health information to medical personnel comprising (a) a registrant assigned a registrant code; (b) a health record management system having a database containing personal data and health information for the registrant associated with the registrant code; and (c) a call center in electronic communication with the health record management system; wherein the personal data includes emergency contact information and the health information includes the registrants current medications, allergies, previously diagnosed medical conditions, blood type, and at least one current physician.

19. The system of claim 18 further comprising a communication link between a computer operable by the registrant and the health record management system.

20. The system of claim 18 further comprising a communication link between the at least one of a healthcare practitioner, a healthcare facility, a pharmacy, and a health insurer, and the health record management system.
